(19) United States
(12) Patent Application Publication
(10) Pub. No.: US 2023/0130051 A1
(43) Pub. Date: Apr. 27, 2023

(54) SHAPEABLE COMPOSITES AND METHODS OF PREPARATION THEREOF

(71) Applicants: Hamed LAKROUT, San Antonio, TX (US); Matthew Y. MENESES, San Antonio, TX (US); Soufiane MOHAND-KACI, San Antonio, TX (US); WESTLAKE ROYAL BUILDING PRODUCTS INC., Houston, TX (US)

(72) Inventors: Hamed LAKROUT, San Antonio, TX (US); Matthew Y. MENESES, San Antonio, TX (US); Soufiane MOHAND-KACI, San Antonio, TX (US)

(73) Assignee: WESTLAKE ROYAL BUILDING PRODUCTS INC., Houston, TX (US)

(21) Appl. No.: 17/995,063

(22) PCT Filed: Mar. 18, 2021
(86) PCT No.: PCT/US2021/022894

§ 371 Date: Sep. 29, 2022

Related U.S. Application Data
(60) Provisional application No. 63/004,637, filed on Apr. 3, 2020.

(51) Int. Cl. C08K 7/26; C08K 11/00; C08K 7/28; C08J 9/00

(52) U.S. Cl. CPC C08K 7/26; C08J 9/0066; C08K 7/28; C08K 11/00; C08K 2003/265; C08K 2201/005

(57) ABSTRACT

Shapeable composites and methods of use and manufacturing arc described herein. The shapeable composites may include a polymer and a functional filler, e.g., the functional filler present in an amount greater than or equal to 40% by weight, based on the total weight of the shapeable composite. The shapeable composite may be a foam composite having a viscoelasticity, such that the shapeable composite is configured to be reshaped.

### CROSS-REFERENCE TO RELATED APPLICATION

This application claims priority to U.S. Provisional Application No. 63/004,637, filed Apr. 3, 2020, which is incorporated by reference herein in its entirety.

### TECHNICAL FIELD

The present disclosure generally relates to shapeable composites, and methods of use and preparation thereof.

### BACKGROUND

Polymer composites are useful for various applications due to their physicochemical properties. While some polymeric composites have mechanical properties such as high levels of rigidity and tensile strength suitable for use in construction materials, such composites can be difficult to use for products with contoured shapes and curvatures.

### SUMMARY

The present disclosure includes shapeable composites and methods of making shapeable composites. For example, the present disclosure includes a shapeable composite, comprising a polymer and a functional filler present in an amount greater than or equal to 40% by weight, based on the total weight of the shapeable composite; wherein the shapeable composite has a flexural strength of greater than or equal to 50 psi; wherein the shapeable composite is a foam composite; and wherein the shapeable composite has a viscoelasticity, such that the shapeable composite is configured to be reshaped. The shapeable composite may have a flexural strength of 40 psi to 500 psi, e.g., 40 psi to 450 psi, or 100 psi to 500 psi. The shapeable composite may have an elastic modulus less than or equal to 30 ksi, such as less than or equal to 10 ksi.

According to some examples herein, the functional filler comprises inorganic particles having an average particle size of 0.1 µm to 800 µm. The functional filler may comprise calcium, silicon, aluminum, magnesium, carbon, or a mixture thereof. In some examples, the functional filler may comprise fly ash, bottom ash, glass microspheres, cenospheres, calcium carbonate, or a combination thereof. The functional filler may be present in an amount of 40% to 60% by weight, relative to the total weight of the shapeable composite. Additionally or alternatively, the shapeable composite may comprise a surfactant, e.g., a silicone surfactant. In some examples herein, the shapeable composite may be reshaped under heat exposure and to retain a curved shape at room temperature following the heat exposure.

In at least one example, the polymer is formed by reaction of an isocyanate and a polyol in a weight ratio of isocyanate:polyol less than 1:5. The polyol may have an average functionality ranging from 1.5 to 5.5, such as e.g., 2.0 to 3.0. Additionally or alternatively, the isocyanate index of the isocyanate may be 50 to 150. The shapeable composite may be in the form of a backer board, e.g., a tile backer board, among other types of materials.

The present disclosure also includes a shapeable composite, comprising a polymer formed by the reaction of an isocyanate and a polyol and a functional filler present in an amount greater than or equal to 40% by weight, based on the total weight of the shapeable composite, the functional filler comprising inorganic particles; wherein at least 15% by weight of the functional filler has an average particle size of 0.1 µm to 800 µm; wherein the shapeable composite is a foam composite; and wherein the shapeable composite has a viscoelasticity, such that the shapeable composite is configured to adopt a curved shape upon application of a force and to retain the curved shape for a period of time when the force is removed. Additionally, the functional filler may comprise calcium, silicon, aluminum, magnesium, carbon, or a mixture thereof. In some examples, the functional filler may comprise fly ash, bottom ash, glass microspheres, cenospheres, calcium carbonate, or a combination thereof. The shapeable composite may have a flexural strength of at least 50 psi and/or an elastic modulus less than or equal to 30 ksi.

Also encompassed herein are building materials comprising the shapeable composites discussed above and elsewhere herein.

The present disclosure also includes methods of making shapeable composites. For example, the method may comprise combining an isocyanate, a polyol, and a functional filler to form a mixture; and foaming the mixture to produce the shapeable composite; wherein the functional filler is present in an amount greater than or equal to 40% by weight, relative to the total weight of the shapeable composite, and wherein the shapeable composite has a viscoelasticity such that the shapeable composite is configured to be reshaped. Additionally, the method may including applying heat to the shapeable composite. The method may also include shaping the shapeable composite into a curved shape by application of a force; and removing the force; wherein the shapeable composite retains the curved shape for a period of time after the force is removed. In at least some examples, the functional filler comprises fly ash, calcium carbonate, or a mixture thereof. The shapeable composite may have a flexural strength of at least 50 psi and/or an elastic modulus less than or equal to 30 ksi.

### DETAILED DESCRIPTION

The singular forms “a,” “an,” and “the” include plural reference unless the context dictates otherwise. The terms “approximately” and “about” refer to being nearly the same as a referenced number or value. As used herein, the terms “approximately” and “about” generally should be understood to encompass ± 5% of a specified amount or value. All ranges are understood to include endpoints, e.g., a molecular weight between 250 g/mol and 1000 g/mol includes 250 g/mol, 1000 g/mol, and all values between.

The present disclosure generally includes shapeable, e.g., bendable, composites comprising a polymer and a functional filler, and methods of preparing such shapeable composites. The shapeable composites herein may be capable of maintaining a desired shape, e.g., following application of a force and/or exposure to heat. For example, the shapeable composite may be shaped by bending, optionally under heat exposure. The shapeable composites herein may have viscoelastic properties, such that the shapeable composites are configured to be reshaped. Viscoelasticity refers to a combination of viscous and elastic properties exhibited by a material. That is, the material exhibits a time-dependent response to strain, e.g., adopting and maintaining a deformed shape upon application of a force (similar to a viscous material) that relaxes towards the original shape over time (similar to an elastic material). Energy applied by an external force is dissipated by the material, unlike a purely elastic material. Viscoelastic materials exhibit hysteresis in the stress-strain curve, wherein the stress applied to the material causes deformation (referred to as creep) that is at least partially maintained after the stress is removed, and the material gradually returns to its original shape (referred to as recovery). As used herein, “reshaped” refers to a shapeable composite that may be shaped, deformed, bent, distorted, contorted, etc., without breaking and/or destroying the shapeable composite. Viscoelastic properties of the shapeable composite may allow the composite to retain a curved or otherwise bent shape once the force and/or heat is removed. For example, the composite may retain a bent shape for a certain period of time, as discussed below. This period of time may be sufficient to attach or fix the composite to a support structure, and permanently lock the shape and position of the composite.

The polymer of the composites herein may be in the form of a foam, e.g., prepared by foaming a mixture comprising at least one isocyanate and at least one polyol. Isocyanates suitable for use in preparing the shapeable composites herein may include at least one monomeric or oligomeric poly- or di-isocyanate. Exemplary diisocyanates include, but are not limited to, methylene diphenyl diisocyanate (MDI), including MDI monomers, oligomers, and combinations thereof. The particular isocyanate used in the mixture may be selected based on the desired viscosity of the mixture used to produce the shapeable composite. For example, a low viscosity may be desirable for ease of handling. Other factors that may influence the particular isocyanate can include the overall properties of the shapeable composite, such as the amount of foaming, strength of bonding to a functional filler, wetting of inorganic fillers in the mixture, strength of the resulting composite, stiffness (elastic modulus), and reactivity.

The polymer of the composites may comprise a thermosetting polymer. For example, the polymer may comprise an epoxy resin, phenolic resin, bismaleimide, polyimide, polyolefin, polyurethane, polystyrene, or a combination thereof.

The polymer may comprise at least one polyol, which may be in liquid form. For example, liquid polyols having relatively low viscosities generally facilitate mixing. Suitable polyols include those having viscosities of 10000 cP or less at 25° C., such as a viscosity of 150 cP to 10000 cP, 200 cP to 8000 cP, 5000 cP to 10,000 cP, 5000 cP to 8000 cP, 2000 to 6000 cP, 250 cP to 500 cP, 500 cP to 4000 cP, 750 cP to 3500 cP, 1000 cP to 3000 cP, or 1500 cP to 2500 cP at 25° C. Further, for example, the polyol(s) may have a viscosity of 8000 cP or less, 6000 cP or less, 5000 cP or less, 4000 cP or less, 3000 cP or less, 2000 cP or less, 1000 cP or less, or 500 cP or less at 25° C.

The polyols useful for the shapeable composites herein may include compounds of different reactivity, e.g., having different numbers of primary and/or secondary hydroxyl groups. In some embodiments, the polyols may be capped with an alkylene oxide group, such as ethylene oxide, propylene oxide, butylene oxide, and combinations thereof, to provide the polyols with the desired reactivity. In some examples, the polyols can include a polypropylene oxide) polyol including terminal secondary hydroxyl groups, the compounds being end-capped with ethylene oxide to provide primary hydroxyl groups.

The polyol(s) useful for the present disclosure may have a desired functionality. For example, the functionality of the polyol(s) may be 7.0 or less, e.g., 1.0 to 7.0, or 2.5 to 5.5. In some examples, the functionality of the polyol(s) may be 6.5 or less, 6.0 or less, 5.5 or less, 5.0 or less, 4.5 or less, 4.0 or less, 3.5 or less, 3.0 or less, 2.5 or less, and/or 1.0 or greater, 2.0 or greater, 2.5 or greater, 3.0 or greater, 3.5 or greater, or 4.0 or greater, or 4.5 or greater, or 5.0 or greater. The average functionality of the polyols useful for the shapeable composites herein may be 1.5 to 5.5, 2.5 to 5.5, 3.0 to 5.5, 3.0 to 5.0, 2.0 to 3.0, 3.0 to 4.5, 2.5 to 4.0, 2.5 to 3.5, or 3.0 to 4.0.

The polyol(s) useful for the shapeable composites herein may have an average molecular weight of 250 g/mol or greater and/or 1500 g/mol or less. For example, the polyol(s) may have an average molecular weight of 300 g/mol or greater, 400 g/mol or greater, 500 g/mol or greater, 600 g/mol or greater, 700 g/mol or greater, 800 g/mol or greater, 900 g/mol or greater, 1000 g/mol or greater, 1100 g/mol or greater, 1200 g/mol or greater, 1300 g/mol or greater, or 1400 g/mol or greater, and/or 1500 g/mol or less, 1400 g/mol or less, 1300 g/mol or less, 1200 g/mol or less, 1100 g/mol or less, 1000 g/mol or less, 900 g/mol or less, 800 g/mol or less, 700 g/mol or less, 600 g/mol or less, 500 g/mol or less, 400 g/mol or less, or 300 g/mol or less. In some cases, the one or more polyols have an average molecular weight of 250 g/mol to 1000 g/mol, 500 g/mol to 1000 g/mol, or 750 g/mol to 1250 g/mol.

Polyols useful for the shapeable composites herein include, but are not limited to, aromatic polyols, polyester polyols, poly ether polyols, Mannich polyols, and combinations thereof. Exemplary aromatic polyols include, for example, aromatic polyester polyols, aromatic polyether polyols, and combinations thereof. Exemplary polyester and poly ether polyols useful in the present disclosure include, but are not limited to, glycerin-based polyols and derivatives thereof, polypropylene-based polyols and derivatives thereof, and poly ether polyols such as ethylene oxide, propylene oxide, butylene oxide, and combinations thereof that are initiated by a sucrose and/or amine group. Mannich polyols are the condensation product of a substituted or unsubstituted phenol, an alkanolamine, and formaldehyde. Examples of Mannich polyols that may be used include, but are not limited to, ethylene and propylene oxide-capped Mannich polyols.

The mixture used to prepare the shapeable composite optionally may comprise one or more additional isocyanate-reactive monomers. When present, the additional isocyanate-reactive monomer(s) can be present in an amount of 30% or less, 25% or less, 20% or less, 15% or less, 10% or less, or 5% or less by weight, based on the weight of the one or more polyols. Exemplary isocyanate-reactive monomers include, for example, polyamines corresponding to the polyols described herein (e.g., a polyester polyol or a poly ether polyol), wherein the terminal hydroxyl groups are converted to amino groups, for example by amination or by reacting the hydroxyl groups with a diisocyanate and subsequently hydrolyzing the terminal isocyanate group to an amino group. For example, the polymer mixture may comprise a poly ether polyamine, such as polyoxyalkylene diamine or polyoxyalkylene triamine.

In some embodiments, the mixture may comprise an alkoxylated polyamine (e.g., alkylene oxide-capped polyamines) derived from a polyamine and an alkylene oxide. Alkoxylated polyamines may be formed by reacting a suitable polyamine (e.g., monomeric, oligomeric, or polymeric polyamines) with a desired amount of an alkylene oxide. The polyamine may have a molecular weight less than 1000 g/mol, such as less than 800 g/mol, less than 750 g/mol, less than 500 g/mol, less than 250 g/mol, or less than 200 g/mol. In some embodiments, the ratio of number of isocyanate groups to the total number of isocyanate reactive groups (e.g., hydroxyl groups, amine groups, and water) in the mixture is 0.5:1 to 1.5:1, which when multiplied by 100 produces an isocyanate index of 50 to 150. In some embodiments, the mixture may have an isocyanate index equal to or less than 140, equal to or less than 130, or equal to or less than 120. For example, with respect to a mixture used to prepare some polymers herein, the isocyanate index may be 80 to 140, 90 to 130, or 100 to 120. Further, for example, with respect to polyisocyanurate foams, the isocyanate index may be 180 to 380, such as 180 to 350 or 200 to 350.

In some embodiments, the isocyanate and the polyol(s) are present in the polymer in a weight ratio (isocyanate:polyol) less than 1:5. For example, the weight ratio may be less than 1:7 or less than 1:10, e.g., a weight ratio of 1:6 to 1:20 or 1:10 to 1:15.

The shapeable composites herein may be prepared with a catalyst, e.g., to facilitate curing and control curing times. Examples of suitable catalysts include, but are not limited to catalysts that comprise amine groups (including, e.g., tertiary amines such as 1,4-diazabicyclo[2.2.2]octane (DABCO), tetramethylbutanediamine, and diethanolamine) and catalysts that contain tin, mercury, or bismuth. The amount of catalyst in the mixture may be 0.01% to 2% based on the weight of the mixture used to prepare the polymer of the composite (e.g., the mixture comprising the isocyanate(s), the polyol(s), and other materials such as foaming agents, surfactants, chain-extenders, crosslinkers, coupling agents, UV stabilizers, fire retardants, antimicrobials, anti-oxidants, cell openers, and/or pigments). For example, the amount of catalyst may be 0.05% to 0.5% by weight, or 0.1% to 0.25% by weight, based on the weight of the mixture used to prepare the polymer. In some embodiments, the mixture may comprise between 0.05 and 0.5 parts per hundred parts of polyol.

In some embodiments of the present disclosure, the amount of polymer may be present in the shapeable composite in an amount of 10% to 65% by weight, such as 25% to 55%, or 20% to 50% by weight, based on the total weight of the shapeable composite. In some examples, the polymer comprises, consists essentially of, or consists of polyurethane. In some examples, the polymer comprises polyurethane and polyurea, e.g., more than 50%, 60%, 70%, 80%, 90%, 95%, or 98% by weight polyurethane and less than 50%, 40%, 30%, 20%, 10%, 5%, or 2% polyurea.

The shapeable composites herein may comprise a functional filler material, such as an inorganic material, e.g., inorganic particles. In some examples, the functional filler comprises calcium, silicon, aluminum, magnesium, carbon, or a mixture thereof. Exemplary functional fillers useful for the shapeable composites herein include, but are not limited to, fly ash, bottom ash, amorphous carbon (e.g., carbon black), silica (e.g., silica sand, silica fume, quartz), glass (e.g., ground/recycled glass such as window or bottle glass, milled glass, glass spheres and microspheres, glass flakes), calcium, calcium carbonate, calcium oxide, calcium hydroxide, aluminum, aluminum trihydrate, clay (e.g., kaolin, red mud clay, bentonite), mica, talc, wollastonite, alumina, feldspar, gypsum (calcium sulfate dehydrate), garnet, saponite, beidellite, granite, slag, antimony trioxide, barium sulfate, magnesium, magnesium oxide, magnesium hydroxide, aluminum hydroxide, gibbsite, titanium dioxide, zinc carbonate, zinc oxide, molecular sieves, perlite (including expanded perlite), diatomite, vermiculite, pyrophillite, expanded shale, volcanic tuff, pumice, hollow ceramic spheres, cenospheres, and mixtures thereof. According to some aspects of the present disclosure, for example, the functional filler comprises two or more different inorganic materials, such as a carbonate (e.g., calcium carbonate) and fly ash.

In some embodiments, the functional filler may comprise an ash produced by firing fuels including coal, industrial gases, petroleum coke, petroleum products, municipal solid waste, paper sludge, wood, sawdust, refuse derived fuels, switchgrass, or other biomass material. For example, the functional filler may comprise a coal ash, such as fly ash, bottom ash, or combinations thereof. Fly ash is generally produced from the combustion of pulverized coal in electrical power generating plants. In some examples herein, the composite comprises fly ash selected from Class C fly ash, Class F fly ash, or a mixture thereof. In some embodiments, the functional filler consists of or consists essentially of fly ash.

The functional filler may have an average particle size greater than or equal to 0.1 µm and/or less than or equal to 1000 µm. For example, at least a portion of the functional filler may have an average particle size of 100 µm to 700 µm, 200 µm to 600 µm, or 300 µm to 500 µm. Further, for example, the functional filler may have an average particle size of 0.1 µm to 100 µm, such as 1 µm to 30 µm, 20 µm to 50 µm, or 40 µm to 70 µm. In some embodiments, the functional filler has an average particle size diameter of 100 µm or more, 150 µm or more, 500 µm or more, or 700 µm or more, e.g., between 100 µm and 450 µm or between 500 µm and 800 µm. In some embodiments, the functional filler has an average particle size of 500 µm or less, 400 µm or less, or 350 µm or less, e.g., between 50 µm and 450 µm or between 200 µm and 350 µm.

The functional filler can be present in the shapeable composite in an amount of greater than or equal to 30% by weight, based on the total weight of the shapeable composite, such as greater than or equal to 35% by weight, greater than or equal to 40% by weight, greater than or equal to 45% by weight, greater than or equal to 50% by weight, greater than or equal to 55% by weight, or greater than or equal to 65% by weight. For example, the amount of functional filler in the composite may be 40% to 60% by weight, e.g., about 45%, about 55%, or about 60%, by weight.

In some examples, at least 15% by weight, at least 30% by weight, or at least 50% by weight of the functional filler may be present as particles having an average particle size of 0.1 µm to 800 µm, based on the total weight of the functional filler. For example, about 15%, about 20%, about 25%, about 30%, about 35%, about 40%, about 45%, about 50%, about 55%, or about 60%, by weight of the functional filler may be present as particles having an average particle size of 10 µm to 800 µm.

In some examples, the shapeable composite comprises one or more organic materials and/or one or more fiber materials. Exemplary organic materials include, for example, polymer particles such as pulverized polymeric foam. The fiber materials can be any natural or synthetic fiber, based on inorganic or organic materials. Exemplary fiber materials include, but are not limited to, glass fibers, silica fibers, carbon fibers, metal fibers, mineral fibers, organic polymer fibers, cellulose fibers, biomass fibers, and combinations thereof.

The shapeable composites herein may comprise at least one additional material, such as, e.g., foaming agents, surfactants, chain-extenders, crosslinkers, coupling agents, UV stabilizers, fire retardants, antimicrobials, anti-oxidants, cell openers, and/or pigments. Exemplary surfactants include, but are not limited to, silicone surfactants.

Methods of preparing the shapeable composites described herein are also disclosed. The shapeable composites herein may be prepared using chemical blowing agents, physical blowing agents, or a combination thereof. The shapeable composites herein may be prepared by free rise foaming or by extrusion. In an exemplary procedure, the polyol, isocyanate, and functional filler (together with other components such as additional isocyanate-reactive monomers, blowing agents, surfactants, fire retardants, or other additives) are combined to form a mixture. The isocyanate may be added together with the other components before mixing, or in some examples, the isocyanate is added after the other components have been mixed together.

In the case of free rise foaming, the mixture is typically added to a mold and set aside to allow the mixture to foam. The resulting shapeable composite can then be cut into a desired shape and/or size, such as sheets or large blocks generally referred to as buns or foam buns. In some embodiments, the foaming may be in a mold or in situ. For instance, the foaming may occur adjacent to a mold surface or a building surface, such that a portion of the foam cell structure contacting such surface compresses or collapses. A portion of the foam cell structure compressed or collapsed may form a skin structure. In the case of extrusion, the mixture may be passed through a vessel of a continuous conveyer system, wherein the mixture foams and is shaped through contact with the walls of the vessel. In both cases, formation of the shapeable composite can be characterized in terms of the cream time, referring to the time at which the mixture starts to foam or expand, and the tack free time, referring to the period from the start of cure/foaming to a point when the material is sufficiently robust to resist damage by touch or settling dirt.

In some embodiments, the method can include forming a polyurethane, polyurea, or polyisocyanurate mixture. The polyurethane, polyurea, or polyisocyanurate mixture can be produced by mixing at least one isocyanate, at least one polyol, and at least one functional filler in a mixing apparatus. The materials can be added in any suitable order. For example, in some embodiments, the mixing stage of the method used to prepare the shapeable composite can include: (1) mixing the polyol and filler; (2) mixing the isocyanate with the polyol and filler, and optionally (3) mixing the catalyst with the isocyanate, the polyol, and the filler.

The shapeable composites herein may include cells that are open or closed. A higher percentage of closed cells is expected to provide a thinner cell structure material with greater thermal insulation, whereas more open cells provide for thicker wall cell structure and mechanically stronger material. The shapeable composites herein may have an open cell content that provides sufficient strength and rigidity, which is measured as the ability of the shapeable composite to deform upon the application of a flexural or compressive stress. Rigidity is also referred to in technical terms as the modulus, which is the ratio of the stress over strain. Flexible composites typically exhibit a modulus of 1 kPa to 1 MPa, whereas rigid composites typically exhibit a modulus between 10 MPa and 1 GPa, while maintaining a low or relatively low density. For example, the shapeable composites herein may have a modulus of 1 kPa to 1 MPa, such as 10 kPa to 80 kPa, 50 kPa to 90 kPa, 25 kPa to 50 kPa, or 10 kPa to 30 kPa. The cell content can be measured by ASTM D6226 - 15.

In some embodiments, the shapeable composite has a low or relatively low density. For example, the shapeable composite may have an average density of 2 lb/ft³ (pcf) to 40 pcf, such as 2 pcf to 40 pcf, 2 pcf to 25 pcf, 4 pcf to 25 pcf, 2 pcf to 10 pcf, or 4 pcf to 10 pcf(1 pcf = 16.0 kg/m³). In some examples, the shapeable composite may have a density greater than or equal to 2 pcf, greater than or equal to 4 pcf, or greater than or equal to 5 pcf, and/or less than or equal to 40 pcf, less than or equal to 30 pcf, less than or equal to 20 pcf, or less than or equal to 10 pcf.

The shapeable composites herein may be capable of maintaining a desired shape, e.g., following exposure to heat. For example, the composite may be shaped by bending under heat exposure, and the composite retains such resulting shape following heat exposure and at room temperature.

The shapeable composites herein may have a compressive strength greater than or equal to 20 psi (145.0 psi = 1 MPa), greater than or equal to 40 psi, or greater than or equal to 60 psi, e.g., 20 psi to 500 psi, 30 psi to 400 psi, 40 psi to 450 psi, 50 psi to 100 psi, 300 to 400 psi, 100 to 250 psi, or 60 psi to 90 psi. Compressive strength can be measured by the stress measured at the point of permanent yield, zero slope, or significant change of the stress variation with strain on the stress-strain curve as measured according to ASTM D1621.

Additionally or alternatively, the shapeable composite may have a flexural strength of 50 psi to 500 psi. For example, the shapeable composite may have a flexural strength of 50 psi or greater, 100 psi or greater, 200 psi or greater, 300 psi or greater, or 400 psi or greater, and/or 500 psi or less, 400 psi or less, 300 psi or less, or 200 psi or less. Flexural strength can be measured as the load required to fracture a rectangular prism loaded in the three point bend test as described in ASTM C947, wherein flexural modulus is the slope of the stress/strain curve at low strain.

The shapeable composites herein may have a modulus of elasticity less than or equal to 100 ksi, less than or equal to 50 ksi, less than or equal to 30 ksi, or less than or equal to 10 ksi. For example, the shapeable composite may have a modulus of elasticity less than 30 ksi, less than 25 ksi, less than 20 ksi, less than 15 ksi, less than 10 ksi, or less than 5 ksi Modulus of elasticity can be measured as described in ASTM C947.

The composites herein may have viscoelastic properties that allow the composites to be shaped, e.g., deformed from their original shapes, and to maintain the deformed shape. For example, the shapeable composites may maintain the deformed, e.g., curved or otherwise bent shape, in a time-dependent manner. In some examples, the shapeable, e.g., bendable, composites may be produced in the form of a flat sheet to facilitate transportation. Once received, the shapeable composite in sheet form may be shaped/re-shaped by the application of a force and/or exposure to heat. As discussed above, the viscoelastic properties of the shapeable composite may allow the composite to retain a curved or otherwise bent shape for a period of time once the force and/or heat is removed. The shapeable composite may exhibit a non-linear, time-dependent stress-strain curve. Viscoelasticity can be measured as the reaction force on a material as described in ASTM D3574. Viscoelasticity can also be measured as the dissipation of dynamic mechanical energy as described in ASTM D5023.

In some examples, the composite may retain the shape for a given period of time and then return to its original, e.g., sheet-like shape. For example, the viscoelastic properties of the composite may allow the composite to retain a curved or otherwise bent shape for at least 1 hour, at least 6 hours, at least 12 hours, or at least 24 hours. In some examples, a force may be applied to a shapeable composite in flat sheet form to cause the composite to adopt a curvature of at least 10 degrees, at least 30 degrees, at least 45 degrees, or at least 60 degrees. Once the force is removed, the composite may retain the curvature for the given period of time (e.g., at least 30 minutes). In some examples, the composite may be configured to retain the curvature indefinitely. In at least one example, the application of heat to the composite while the composite has the desired curvature may allow the composite to retain the curvature for a longer period of time, e.g., at least 24 hours, at least 1 week, at least 1 month, at least 1 year, or indefinitely. Applying heat to the composite may facilitate shaping, e.g., bending, of the composite. Without intending to be bound by theory, it is believed that applying heat may provide for easier change of the molecular configuration of the polymeric chains as the temperature of the material gets closer to its glass transition temperature. Thus, for example, applying heat may lower the energy necessary for the composite structure to bend, and allow for a longer recovery time. For example, once the composite cools down to room temperature, the polymeric molecule may require more time to change configuration, and therefore the composite may appear to become rigid and retain its curvature. In some examples, the composite may retain its curvature until an external stress is exerted on the composite.

The shapeable composites herein may combine flexible properties with desired compressive strength, such that the composite may be suitable for use in building products. For example, the shapeable composites herein may have compressive strength and/or other mechanical properties comparable to materials such as plywood, particle board, and other wood-or fiber-based materials.

The shapeable composites herein may be used for any desirable type of building product, such as a support material. For example, the shapeable composite may be a backer board to be used in combination with, for example, tiles, walls, floors, countertops, tub and shower areas, beams, columns, arches, archways, and ceilings, for both interior and exterior areas and structures.

In some embodiments of the present disclosure, the building product comprising the shapeable composite does not include a facing material, e.g., a coating. In other examples of the present disclosure, the building product comprises a shapeable composite with one or more layers of a facing material. The facing material may include polymeric cement, fiber mesh, fillers, or mixtures thereof. In some examples of the present disclosure, the building product comprising a shapeable composite may have one or more layers of a facing material on at least one side of the building product or at least two sides of the building material.

The shapeable composites herein can be prepared with any desired dimensions or shapes. According to some aspects of the present disclosure, the composite may be prepared as a flat sheet (in rectangular shape having a length, a width, and a thickness) to be shaped and/or re-shaped as desired. For example, the composite may have a length (measured along the x-axis) of greater than or equal to 2 feet, a width (measured along the y-axis) greater than or equal to 10 inches, and a thickness (measured along the z-axis) of 0.1 inches to 3 inches. Further, for example, the composite may have length of 2 feet to 15 feet, such as 4 feet to 8 feet; a width of 4 inches to 2 feet, such as 10 inches to 1 foot; and a thickness of 0.1 inches to 6 inches, such as 0.2 inches to 0.4 inches. In at least one example, the composite has a length of 4 feet and a width of 10 inches. In another example, the composite has a length of 3 feet and a width of 5 inches. The average thickness (measured along the z-axis) of the shapeable composites can be equal to or greater than 0.20 inches. According to some examples herein, the average thickness of the shapeable composite can range from 0.20 inches to 3 inches, such as from 0.5 inches to 2 inches, from 1 inch to 2 inches, from 0.5 inches to 1.5 inches or from 0.25 inches to 0.50 inches. The shapeable composites may have a radius of curvature ranging from 0.1 inches to 2 inches, such as 0.25 inches to 1 inch or 0.5 inches to 1 inch.

The shapeable composites herein may be bendable independent of orientation, e.g., bendable in multiple directions and/or along multiple axes. For example, the composite may be bendable along the length (e.g., along the x-axis, in one or both directions along the z-axis), along the width (e.g., along the y-axis, in one or both directions along the z-axis), and/or any other direction. In some examples, the composite may be bendable so as to form a recessed area, e.g., such that the composite may deform to cover a curved surface such as a sphere or ovoid body.

A person of ordinary skill in the art will recognize that the shapeable composite need not be prepared in sheet-like form and other dimensions and shapes than those provided above are encompassed herein.

Methods of simulating and/or manipulating the shapeable composites described herein are also disclosed. For example, the shapeable composites may be simulated on a user interface such that various aspects of the boards, e.g., flexural strength or viscoelasticity, are preset in the simulation. A user may then manipulate the shapeable composites on the user interface, such that the preset properties either limit the shapeable composites’ ability to be manipulated (e.g., bent, reshaped) or change colors to indicate the limits of shapeable composites. The user interface may be a display screen connected to, or used in connection with a computer processing unit.

While principles of the present disclosure are described herein with reference to illustrative aspects for particular applications, the disclosure is not limited thereto. Those having ordinary skill in the art and access to the teachings provided herein will recognize additional modifications, applications, aspects, and substitution of equivalents that all fall in the scope of the aspects described herein. Accordingly, the present disclosure is not to be considered as limited by the foregoing description.

1. A shapeable composite comprising:
a polymer; and
a functional filler present in an amount greater than or equal to 40% by weight, based on the total weight of the shapeable composite;
wherein the shapeable composite has a flexural strength of greater than or equal to 50 psi;
wherein the shapeable composite is a foam composite; and
wherein the shapeable composite has a viscoelasticity, such that the shapeable composite is configured to be reshaped.

2. The shapeable composite of claim 1, wherein the shapeable composite has a flexural strength of 100 psi to 500 psi or an elastic modulus of less than or equal to 30 ksi.

3. (canceled)

4. (canceled)

5. The shapeable composite of claim 1, wherein the functional filler comprises inorganic particles having an average particle size of 0.1 µm to 800 µm, and wherein the functional filler comprises calcium, silicon, aluminum, magnesium, carbon, or a mixture thereof.

6. (canceled)

7. The shapeable composite of claim 1, wherein the functional filler comprises fly ash, bottom ash, glass microspheres, cenospheres, calcium carbonate, or a combination thereof.

8. The shapeable composite of claim 1, wherein the functional filler is present in an amount of 40% to 60% by weight, relative to the total weight of the shapeable composite.

9. The shapeable composite of claim 1, wherein the shapeable composite comprises a surfactant.

10. The shapeable composite of claim 1, wherein the shapeable composite is configured to be reshaped under heat exposure and to retain a curved shape at room temperature following the heat exposure.

11. The shapeable composite of claim 1, wherein the polymer is formed by reaction of an isocyanate and a polyol in a weight ratio of isocyanate:polyol less than 1:5.

12. The shapeable composite of claim 11, wherein the polyol has an average functionality ranging from 1.5 to 5.5, wherein an isocyanate index of the isocyanate is 50 to 150, or wherein the polyol has an average functionality ranging from 1.5 to 5.5 and an isocyanate index of the isocyanate is 50 to 150.

13. The shapeable composite of claim 11, wherein an isocyanate index of the isocyanate is 50 to 150.

14. A building product comprising the shapeable composite of claim 1.

15. The building product of claim 14, wherein the shapeable composite is a tile backer board.

16. A shapeable composite comprising:
a polymer formed by the reaction of an isocyanate and a polyol; and
a functional filler present in an amount greater than or equal to 40% by weight, based on the total weight of the shapeable composite, the functional filler comprising inorganic particles;
wherein at least 15% by weight of the functional filler has an average particle size of 0.1 µm to 800 µm;
wherein the shapeable composite is a foam composite; and
wherein the shapeable composite has a viscoelasticity, such that the shapeable composite is configured to adopt a curved shape upon application of a force and to retain the curved shape for a period of time when the force is removed.

17. (canceled)

18. The shapeable composite of claim 16, wherein the functional filler comprises fly ash, bottom ash, glass microspheres, cenospheres, calcium carbonate, or a combination thereof.

19. The shapeable composite of claim 16, wherein the shapeable composite has a flexural strength of at least 50 psi and/or an elastic modulus less than or equal to 30 ksi.

20. A method of making a shapeable composite, the method comprising:
combining an isocyanate, a polyol, and a functional filler to form a mixture; and
foaming the mixture to produce the shapeable composite;
wherein the functional filler is present in an amount greater than or equal to 40% by weight, relative to the total weight of the shapeable composite, and
wherein the shapeable composite has a viscoelasticity such that the shapeable composite is configured to be reshaped.

21. The method of claim 20, further comprising applying heat to the shapeable composite.

22. The method of claim 20, further comprising:
shaping the shapeable composite into a curved shape by application of a force; and
removing the force;
wherein the shapeable composite retains the curved shape for a period of time after the force is removed.

23. The method of claim 20, wherein the functional filler comprises fly ash, calcium carbonate, or a mixture thereof.

24. The method of claim 20, wherein the shapeable composite has a flexural strength of at least 50 psi and/or an elastic modulus less than or equal to 30 ksi.
